(19) United States
(12) Patent Application Publication
(10) Pub. No.: US 2006/0092983 A1
(43) Pub. Date: May 4, 2006

(54) Clock generating apparatus

(75) Inventors: Satoshi Kataoka, Ome-shi (JP); Mitsutaka Kuwabara, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/261,603

(22) Filed: Oct. 31, 2005

(30) Foreign Application Priority Data
Nov. 2, 2004 (JP) 2004-319691

(51) Int. Cl. H04J 3/06

(52) U.S. Cl. 370/503

(57) ABSTRACT

A clock generating apparatus includes a first PLL circuit configured to generate a sync clock in phase with reference time information from a data stream, an oscillator configured to generate a fixed clock, a control unit configured to output a clock switching signal, and a clock switching unit configured to selectively switch the sync clock and the fixed clock to each other in accordance with the clock switching signal and output the selected clock as a system clock.

### CROSS-REFERENCE TO RELATED APPLICATIONS

This application is based upon and claims the benefit of priority from prior Japanese Patent Application No. 2004-319691, filed Nov. 2, 2004, the entire contents of which are incorporated herein by reference.

### BACKGROUND OF THE INVENTION

1. Field of the Invention

The present invention relates to an apparatus for generating a system clock in synchronism with a data stream such as a MPEG transport stream.

2. Description of the Related Art

As is well known, the video and audio signals for the digital broadcast are compression coded by the technique such as MPEG (moving picture expert group) and broadcast by a satellite communication network or the like. At the receiving end, the encoded bit stream is decoded in real time, and after being appropriately converted into an analog signal, output to a monitor output unit and thus the viewer can view and hear the broadcast image and sound.

The digital broadcast receiver or the digital broadcast tuner is equipped with a clock generating unit for generating a clock of 27 MHz, for example, in synchronism with the reference time information such as PCR (program clock reference) contained in the encoded bit stream (MPEG2-TS (transport stream)) received (Jpn. Pat. Appln. KOKAI Publication No. 2002-15527).

In Jpn. Pat. Appln. KOKAI Publication No. 2002-15527, a single voltage-controlled variable crystal oscillator (VCXO) can selectively produce a clock synchronous with the reference time information contained in the digital data and a clock of a fixed frequency. At the receiving end, therefore, the clock of the same phase as that at the transmitting end is generated. Thus, the encoded data can be decoded without developing any overflow or underflow of the buffer for temporarily storing the encoded data. Also, even during the protracted receiving operation, the image and the sound can be received without any disorder.

In the case where MPEG2-TS from the digital broadcast tuner is input to and recorded by a recording and reproducing apparatus, a clock generator forms a PLL (phase locked loop) thereby to produce a clock synchronous with the PCR contained in MPEG2-TS. At the time of reproduction from a disk or the like in which a digital broadcast is recorded, the clock of the fixed frequency of 27 MHz is produced from the voltage-controlled variable crystal oscillator VCXO.

In the case where the clock of the fixed frequency is generated using the clock generating apparatus having this configuration, the clock is required to be output while changing the control voltage of VCXO to a fixed frequency at the time of reproduction. In view of the fact that the VCXO oscillation is affected by the control voltage, however, the clock produced unavoidably contains jitters.

### BRIEF SUMMARY OF THE INVENTION

According to one aspect of the present invention, there is provided a clock generating apparatus comprising: a first PLL circuit configured to generate a sync clock in phase with reference time information from a data stream; an oscillator configured to generate a fixed clock; a control unit configured to output a clock switching signal; and a clock switching unit configured to selectively switch the sync clock and the fixed clock to each other in accordance with the clock switching signal from the control unit and output the selected clock as a system clock.

### BRIEF DESCRIPTION OF THE SEVERAL VIEWS OF THE DRAWING

FIG. 1 is a diagram showing a block configuration for explaining an information recording and reproducing apparatus according to an embodiment of the invention;

FIG. 2 is a diagram showing a block configuration for explaining a clock generating unit of the information recording and reproducing apparatus according to the same embodiment; and

FIG. 3 is a flowchart for explaining the steps of switching a system clock of the clock generating unit according to the same embodiment.

### DETAILED DESCRIPTION OF THE INVENTION

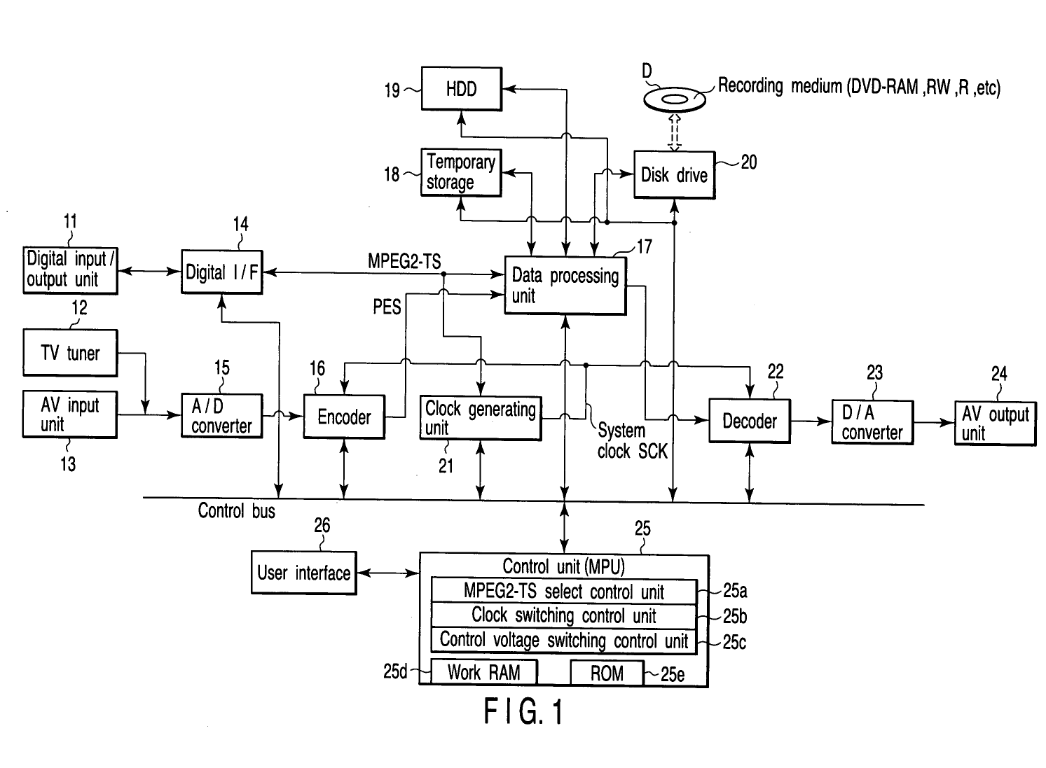

An embodiment of the invention is explained in detail below with reference to the drawings. FIG. 1 is a diagram showing a general configuration of an information recording and reproducing apparatus according to this embodiment of the invention. The apparatus shown in FIG. 1 includes a digital input/output unit 11, a TV tuner 12, an AV input unit 13, a digital I/F 14, an A/D converter 15, an encoder 16, a data processing unit 17, a temporary storage unit 18, a hard disk drive (HDD) 19, a disk drive 20, a recording medium (an optical disk of RAM (random access memory) type, RW (read-write) type or write-once (R) type using red or blue laser) D, a clock generating unit 21, a decoder 22, a D/A converter 23, an AV output unit 24, a control unit 25 and a user interface 26. Though not shown, a digital recorder using a magnetic tape as a recording medium or a semiconductor recorder using a large-capacity flash memory may be connected to the data processing unit 17 for digital recording and reproducing operation.

The control unit 25 is configured of a microprocessing unit (MPU), and the control software (firmware) thereof includes a MPEG2-TS select control unit 25a, a clock switching control unit 25b and a control voltage switching control unit 25c (a ROM area for firmware not shown is included in the MPU 25). This control unit (MPU) 25 further includes a work RAM 25d used for the work area of the control program, and a ROM 25e for storing the various parameters required for execution of the control program and an on-screen display (OSD) data for the user interface.

The MPEG2-TS select control unit 25a of the control unit 25, upon receipt of the input select signal of the user operating the remote control (not shown) from the user interface 26, selects the digital signal input or the analog signal input while controlling the data processing unit 17. A digital signal to be selected includes the MPEG2-TS signal (the MPEG2-PS signal may be included as a signal to be selected according to some embodiments) from the digital input/output unit 11, while an analog signal to be selected includes the PES (packetized elementary stream) signal digitized by A/D conversion of the analog AV signal from the TV tuner 12 and/or the AV input unit 14 (PES corresponds to each signal packet multiplexed in the PS (program stream) of MPEG2). Specifically, the MPEG2-TS select control unit 25a is configured to output a select signal for selectively switching the PES between MPEG2-TS and MPEG2-PS. The data processing unit 17 is configured to process the packets of TS or PES selectively switched by the select signal.

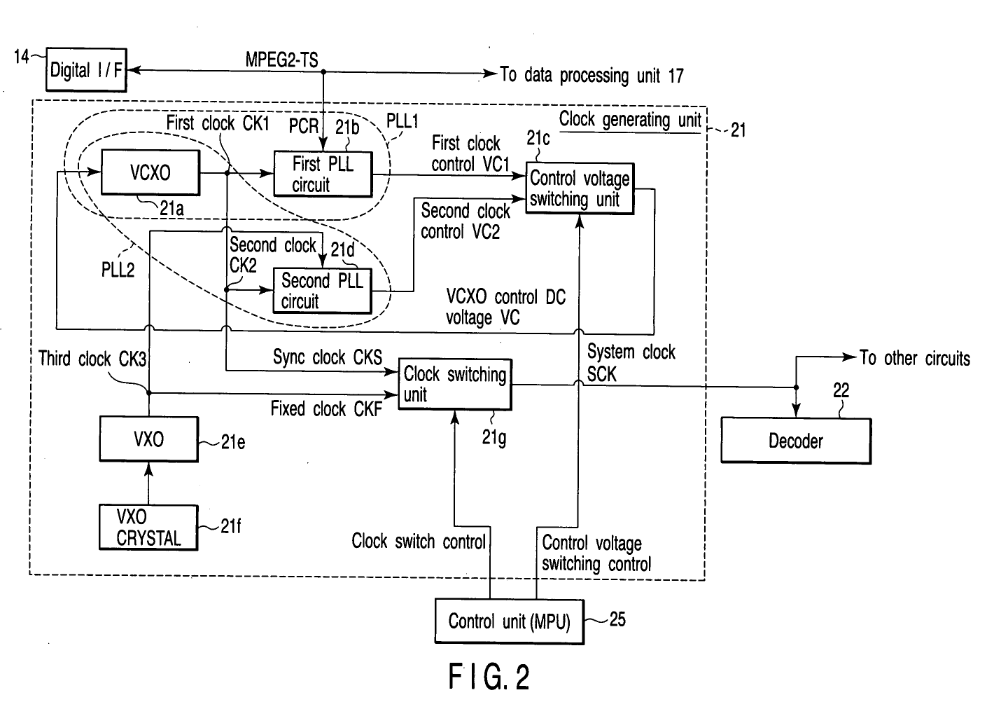

The clock switching control unit 25b and the control voltage switching control unit 25c of the control unit 25, on the other hand, control the clock generating unit 21 according to whether the selected input signal is a digital signal (MPEG2-TS, etc.) or not. The detail of this operation is described later with reference to FIG. 2.

The configuration for writing or reading (recording and/or reproducing) information into or from the recording medium D includes the disk drive 20 having an optical system and a drive system, the data processing unit 17, the temporary storage unit 18 and the clock generating unit (a system time counter or a system time clock (STC)) 21. The temporary storage unit 18 is used as a buffer to store a predetermined amount of the data written into the recording medium D (the data output from the encoder 16) through the data processing unit 17 and the disk drive 20, or as a buffer to store a predetermined amount of the data reproduced from the recording medium D (the data input to the decoder 22) through the disk drive 20 and the data processing unit 17. The disk drive 20 includes a rotation control system, a laser drive system and an optical system for the optical disk.

The analog video signal and the analog audio signal output from the TV tuner 12 and/or the AV input unit 13 are converted into a digital video/audio signal by the A/D converter 15. The video/audio signal is encoded by the encoder 16. Specifically, the video signal is compressed according to, for example, the MPEG2 compression coding scheme, while the audio signal is encoded by LPCM (linear pulse code modulation) in accordance with a mode selected in advance or according to the audio digital compression scheme (MP2, AAC, AC-3, etc.). Thus, a compressed stream (MPEG2-PS signal) with the video and audio signals multiplexed is generated. The encoded data (MPEG2-PS) or the digitally input data stream (MPEG2-TS, etc.) are recorded in the recording medium D via the disk drive 20 and/or in the HDD 19 through the data processing unit 17.

At the time of reproduction, on the other hand, the reproduction data (MPEG2-TS or MPEG2-PS) is supplied to the data processing unit 17 from the recording medium D through the disk drive 20 or from the HDD 19, and the decoder 22 outputs the decoded video/audio signal. Further, the digital video/audio signal is converted into an analog video/audio signal by the D/A converter 23. Finally, the analog video/audio signal is output to the AV output unit 24, and can be viewed on the ordinary TV receiver. All of these operations are controlled by the control unit 25 through a control bus in response to an instruction from the user interface 26.

In the information recording and reproducing apparatus shown in FIG. 1, the digital I/F 14 is connected between the digital input/output unit 11 and the data processing unit 17 through a bidirectional bus. Since an external device (not shown) is connected to the digital input/output unit 11 through a digital link, the encoded video/audio data (the data stream such as MPEG2-TS) from the external device can be recorded in the recording medium D and the encoded video/audio data (the data stream such as MPEG2-TS) reproduced from the recording medium D can be output to the external device.

The external device connected as described above includes a digital broadcast receiver or a digital broadcast tuner (set top box: STB). The interface of the digital link between the external device and the information recording and reproducing apparatus shown in FIG. 1 can use the I/F complying with IEEE

(Institute of Electrical and Electronics Engineers)

1394 Standard.

The encoded video/audio data input to the digital input/output unit 11 from the external device is appropriately converted or otherwise processed in the digital I/F 14 into a format (MPEG2-TS or MPEG2-PS) adapted to the information recording and reproducing apparatus. The resulting video/audio data are recorded in the recording medium D via the disk drive 20 and/or the HDD 19 through the data processing unit 17. At the same time, the MPEG2-TS and PES to be recorded are separated from each other at the data processing unit 17, and the separated PES is supplied to the MPEG video/audio decoder 22. In this way, the analog video signal and the analog audio signal corresponding to the video/audio data from the external device are output to the AV output unit 24.

In the case where the decoder 22 has the function of decoding MPEG2-TS, the system can be configured so that the MPEG2-TS can be transmitted from the data processing unit 17 to the decoder 22. In this case, the reproduced image of the contents of the MPEG2-TS recorded (or being recorded) in the HDD 19 and/or the recording medium D can be sent to the AV output unit 24 without using the built-in decoder such as STB, not shown, externally connected through the IEEE1394 or the like.

FIG. 2 is a diagram showing a block configuration of an example of the clock generating unit 21. With the information recording and reproducing apparatus having the configuration shown in FIG. 1, an explanation is made below about a case in which a digital broadcast tuner (STB not shown) is connected as an external device and the encoded bit stream (MPEG2-TS, etc.) received by the digital broadcast tuner is input to the information recording and reproducing apparatus and recorded in the HDD 19 (and/or the optical disk D mounted on the disk drive 20), and then, the encoded bit stream reproduced from the HDD 19 (and/or the optical disk D) is decoded and output to the AV output unit 24.

FIG. 2 shows an example of the clock generating unit 21 of the information recording and reproducing apparatus according to this embodiment. In this configuration, the clock generating unit 21 includes a voltage-controlled variable crystal oscillator (VCXO) 21a, a first PLL circuit 21b, a control voltage switching unit 21c, a second PLL circuit 21d, a crystal oscillator (VXO) 21e and a VXO crystal transducer (CRYSTAL) 21f.

The clock generating unit 21 includes the VCXO 21a with the oscillation frequency adapted to change within a predetermined range around 27 MHz in accordance with the control voltage, the first PLL circuit 21b forming a first phase locked loop PLL 1 with the VCXO 21a, and the second PLL circuit 21d forming a second phase locked loop PLL 2 with the VCXO 21a.

During the operation of the PLL 1, the first clock control voltage VC1 from the first PLL circuit 21b is selected by the control voltage switching unit 21c in such a manner that the clock CK1 from the VCXO 21a is locked in phase (synchronized) with the PCR (or the SCR (system clock reference) contained in MPEG2-PS) constituting the reference time information contained in MPEG2-TS output to the bidirectional bus from the digital I/F 14 (PCR is somewhat varied from one broadcast station to another, and therefore, the clock synchronous with PCR for each broadcast station is required for handling the data stream from various broadcast stations).

During the operation of the PLL 2, on the other hand, the second clock control voltage VC2 from the second PLL circuit 21d is selected by the control voltage switching unit 21c in such a manner that the clock CK2 from the VCXO 21a is locked in phase (synchronized) with the fixed clock CK3 from the VXO 21e.

Specifically, in the case where the control voltage switching unit 21c is operated to activate the PLL 1, the sync clock CKS (=CK1) locked in phase (synchronized) with the reference time information (PCR, etc.) contained in the digital input (data stream such as MPEG2-TS) is produced from the VCXO 21a. In the case where the control voltage switching unit 21c is operated to activate the PLL 2, on the other hand, the sync clock CKS locked in phase (synchronized) with the fixed clock CK3 from the VXO 21e is produced from the VCXO 21a. In the process, the VXO 21e oscillates in a stable fashion (at the oscillation frequency of, say, 27 MHz) independently of the digital input (the data stream such as MPEG2-TS).

Whenever the system clock SCK in phase with the digital input (the data stream such as MPEG2-TS) is required, the sync clock CKS (=CK1) is selected by the operation of the PLL 1. At the time of disk reproduction, for example, the sync clock is temporarily locked in phase with the VXO 21e by the operation of the PLL 2, after which the fixed clock CKF (=CK3) is selected as the system clock SCK. During the process of switching the sync clock CKS (=CK1) to the fixed clock CKF (=CK3), therefore, the clock interruption can be avoided by the intermediary of clock CK2 synchronized with CK3.

According to this embodiment, the sync clock CKS is locked in phase with PCR of MPEG2-TS. According to another embodiment, however, the sync clock CKS may be locked in phase with another time reference value (such as SCR of MPEG1-PS or MPEG2-PS).

The control voltage switching unit 21c is so configured as to select the first PLL circuit 21b (PLL 1) or the second PLL circuit 21d (PLL 2) based on the control voltage switching signal of the control unit 25. The clock switching unit 21g is so configured as to switch between the sync clock CKS (first clock CK1 or second clock CK2) and the fixed clock CKF (third clock CK3) based on the clock switching signal from the control unit 25.

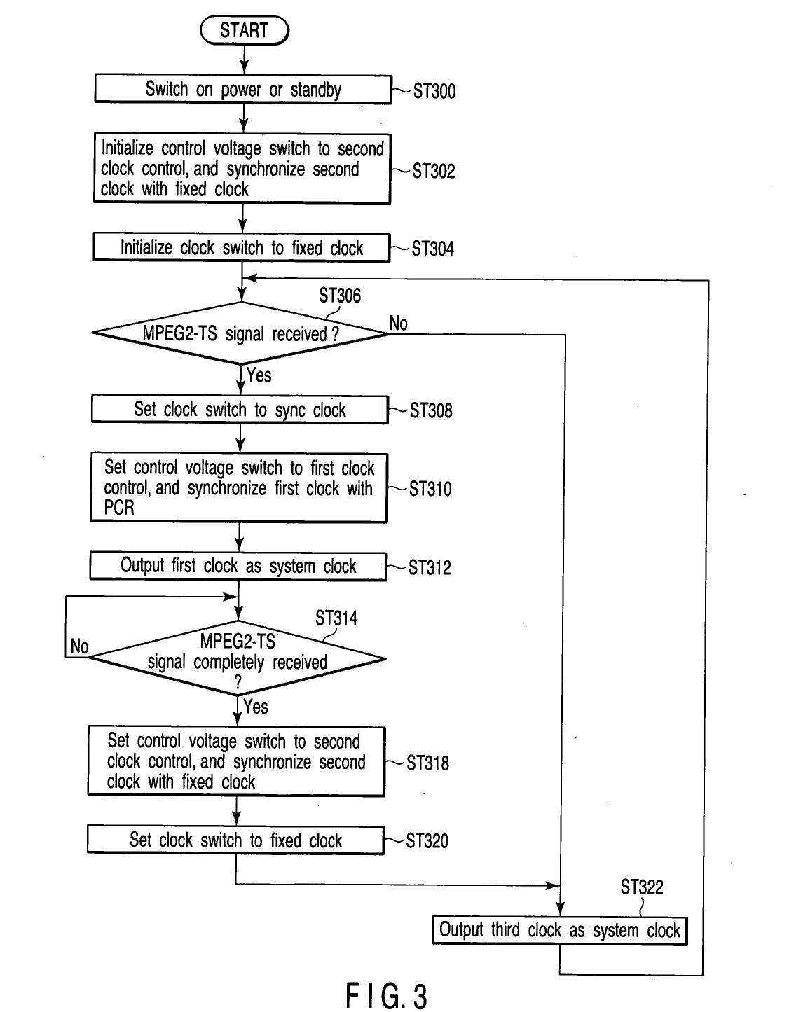

FIG. 3 is a flowchart for explaining the steps of switching the system clock in the clock generating unit 21. The process of this flowchart can be executed by the MPU 25 shown in FIG. 1, and the steps of this process can be written as firmware such as the clock switch control unit 25b.

Once the information recording and reproducing apparatus is powered on, the process is started (step ST300). First, the control unit 25, in order to generate a sync clock synchronized with the fixed clock as an initialization step (i.e. in preparation for switching between the fixed clock and the sync clock), sets the control voltage switching unit 21b to the second clock control side in such a manner as to activate the second PLL circuit 21d (PLL 2 system) (step ST302). As a result, the second clock CK2 in synchronism with the fixed clock CKF is generated. In order to set the system clock SCK to the third clock CK3 of the fixed frequency VXO 21e, on the other hand, the clock switching unit 21g is set to the fixed clock side (step ST304).

Next, at the time of the select operation of the digital broadcast tuner connected to the digital input/output unit 11, it is determined whether the MPEG2-TS signal is newly received or not (step ST306). In the case where the determination at step ST306 is YES, i.e. in the case where the MPEG2-TS signal is newly received, the control unit 25 outputs the clock switching signal to the clock switching unit 21g, so that the fixed clock is switched to the sync clock. Thus, the second clock CK2 constituting the sync clock input from the VCXO 21a is output as a system clock SCK (step ST308).

Next, the control unit 25 outputs the control voltage switching signal to the control voltage switching unit 21c to activate the first PLL circuit 21b (PLL 1 system), so that the control voltage switching unit 21c is switched to the first clock control, thereby generating the first clock in synchronism with PCR as the reference time information contained in the MPEG2-TS signal (step ST310). As a result, the sync clock CKS is changed from second clock CK2 to first clock CK1 and output as a system clock SCK (=CK1) (step ST312).

Next, it is determined whether the MPEG2-TS signal has ceased to be output or not (step ST314). In the case where the determination at step ST314 is NO, i.e. in the case where the MPEG2-TS signal is sustained, the first clock continues to be output as a system clock (SCK=CK1).

In the case where the determination at step ST314 is YES, i.e. in the case where the MPEG2-TS signal has ceased to be output, on the other hand, the control unit 25 outputs the control voltage switching signal to the control voltage switching unit 21c, which is thus switched to the second clock to activate the second PLL circuit 21d. Then, the sync clock CKS from the VCXO 21a changes to the second clock in phase with the fixed clock CKF (=third clock CK3) of the VXO 21e from the first clock CK1 in phase with the PCR of the MPEG2-TS signal (step ST318).

Then, the control unit 25 outputs a clock switching signal to the clock switching unit 21g, which is thus switched to the fixed clock (step ST320). As a result, the third clock CK3 is output as a system clock SCK (step ST322).

As described above, the clock CKS (=CK1) synchronized with PCR adapted to vary from one broadcast station to another is switched to the stable fixed clock CKF (=CK3) independent of PCR not directly but through the intermediary of CK2 (=locked in phase with CK3). (In spite of the possibility that CK1 and CK3 are asynchronous with each other, CK1 is changed to CK2 continuously by the PLL operation and therefore the clock is not interrupted. On the other hand, CK2 and CK3 are synchronous with each other, and therefore the clock is not interrupted during the switching from CK2 to CK3). This fact is one of the important points of this embodiment.

Then, it is determined whether the MPEG2-TS signal is received or not (step ST306). In the case where the determination at step ST306 is NO, i.e. in the case where the MPEG2-TS signal is not received, the third clock continues to be output as a system clock (SCK=CK3).

The embodiment described above is so configured as to selectively produce the clock CK1 in synchronism with the reference time information (PCR) contained in the data stream at the time of receiving the MPEG2-TS data stream, for example, or the clock signal CK3 of the fixed frequency from the VXO (variable X'tal oscillator) otherwise. The VXO is configured of an oscillator capable of independently oscillating at a stable predetermined frequency with lower jitters than the voltage-controlled oscillator VCXO.

The fixed clock (VXO) and the sync clock (VCXO), before being switched to each other, are required to be synchronized with each other. Otherwise, the clock may be interrupted. In the case where the sync clock (VCXO) is switched to the fixed clock (VXO), therefore, a PLL is formed to lock the clock generating unit in phase with VXO and the sync clock (VCXO) is synchronized with the fixed clock (VXO), after which the VCXO in phase with the VXO is switched to the fixed clock VXO.

The clock switching unit 21g for switching the fixed clock and the sync clock to each other is configured to output the fixed clock as a system clock during the standby for or at the time of switching on power.

Also, the clock switching unit 21g may be configured to output the fixed clock as the system clock in the case where the data stream is not detected.

As another alternative, the sync clock in synchronism with the reference time information from the data stream is generated and one of the sync clock and the predetermined fixed clock is output as a system clock.

At the time of receiving the digital broadcast signal or the like, a system clock in keeping with the reference time information of the received data stream (for example, the sync clock locked in phase with PCR) is accurately generated, and at the time of disk reproduction, the system clock having a minimum frequency variation low in jitters and high in purity (for example, the fixed clock obtained from the crystal oscillator having a configuration independent of external effects) is produced. In this way, an environment suitable for each reproduction session is realized and the optimum video processing operation is made possible.

As described above, according to the embodiments of this invention, a system clock in keeping with the reference time information of the received data stream is accurately generated at the time of receiving the digital broadcast signal, and further, a system clock having a minimum frequency variation low in jitters and high in purity is produced at the time of disk reproduction (in accordance with the grade of the crystal transducer 21f used). By doing so, an environment suitable for each reproduction session is realized and the optimum video processing operation is made possible.

This invention is not limited to the embodiments described above, based on the techniques applicable in each stage of application at present or in the future, and can be variously modified without departing from the spirit and scope thereof. For example, the embodiments have been explained above on the assumption that the data stream passing through the digital input/output unit 11 shown in FIG. 1 is the MPEG2-TS used in the digital broadcasting. Nevertheless, the invention is not limited to MPEG2-TS, and the data stream may be the bit stream of MPEG4 (H264) or the DVD streamer (DVD-SR), though yet to be commercially available.

Also, any of the embodiments described above may be combined appropriately with the corresponding effect of combination. Further, the embodiments described above include various stages of the invention, and by appropriate combination of a plurality of the constituent elements disclosed, various aspects of the invention can be extracted. Even in the case where some of the constituent elements are deleted from all the constituent elements shown in the embodiments, the configuration with the particular constituent elements deleted can be extracted as an aspect of the invention.

What is claimed is:

1. A clock generating apparatus comprising:
a first PLL circuit configured to generate a sync clock in phase with reference time information from a data stream;
an oscillator configured to generate a fixed clock;
a control unit configured to output a clock switching signal; and
a clock switching unit configured to selectively switch the sync clock and the fixed clock to each other in accordance with the clock switching signal from the control unit and output the selected clock as a system clock.

2. A clock generating apparatus comprising:
a first PLL circuit configured to generate a first sync clock synchronized with reference time information from a data stream;
an oscillator configured to generate a fixed clock;
a second PLL circuit configured to generate a second sync clock synchronized with the fixed clock;
a control unit configured to output a control voltage switching signal and a clock switching signal;
a control voltage switching unit configured to switch, by the control voltage switching signal from the control unit, between the first sync clock generated by the first PLL circuit and the second sync clock generated by the second PLL circuit, and output the switched clock as a sync clock from selected one of the first PLL circuit and the second PLL circuit; and
a clock switching unit configured to selectively switch between the fixed clock and the sync clock by the clock switching signal from the control unit and output the selected clock as a system clock.

3. A clock generating apparatus according to claim 2,
wherein the clock switching unit switches the sync clock to the fixed clock in the case where the second sync clock is outputted as the sync clock.

4. An information recording and reproducing apparatus comprising:
a drive unit configured to perform a recording or reproducing operation using an information recording medium;
a clock generating apparatus configured to generate a system clock; and
a recording and reproducing unit configured to perform selected one of an operation of recording a data stream in a predetermined format in the information recording medium using the system clock and an operation of reproducing the information so recorded;
wherein the clock generating apparatus comprises:
a first PLL circuit configured to generate a first sync clock synchronized with reference time information from the data stream;
an oscillator configured to generate a fixed clock;
a second PLL circuit configured to generate a second sync clock synchronized with the fixed clock;
a control unit configured to output a control voltage switching signal and a clock switching signal;
a control voltage switching unit configured to switch, by the control voltage switching signal from the control unit, between the first sync clock generated by the first PLL circuit and the second sync clock generated by the second PLL circuit, and output the switched clock as a sync clock from the first PLL circuit or the second PLL circuit; and
a clock switching unit configured to selectively switch between the fixed clock and the sync clock by the clock switching signal from the control unit and output the selected clock as the system clock.

5. An information recording and reproducing apparatus according to claim 4,
wherein the control unit is configured to output a select signal which selectively switches an MPEG transport stream and an MPEG packetized elementary stream; and
the information recording and reproducing apparatus further comprises a data processing unit configured to process the packets of selected one of the transport stream and the packetized elementary stream selectively switched by the select signal.

6. An information recording and reproducing apparatus according to claim 5,
wherein the control voltage switching unit is set to generate the first sync clock and the clock switching unit is set to output the first sync clock as the system clock upon selection of the transport stream by the select signal from the control unit.

7. An information recording and reproducing apparatus according to claim 5,
wherein the control voltage switching unit is set to generate the second sync clock and the clock switching unit is set to subsequently output the fixed clock as the system clock upon selection of the packetized elementary stream by the select signal from the control unit.

8. An information recording and reproducing apparatus according to claim 4,
wherein the clock switching unit is configured to output the fixed clock as the system clock during standby for and at the time of switching on power.

9. An information recording and reproducing apparatus according to claim 4,
wherein the clock switching unit is configured to output the fixed clock as the system clock in the case where the data stream is not detected.
